(19) United States
(12) Patent Application Publication
(10) Pub. No.: US 2024/0001943 A1
(43) Pub. Date: Jan. 4, 2024

(54) DRIVING DIAGNOSIS DEVICE, DRIVING DIAGNOSIS SYSTEM, DRIVING DIAGNOSIS METHOD, AND STORAGE MEDIUM

(71) Applicant: TOYOTA JIDOSHA KABUSHIKI KAISHA, Aichi-ken (JP)

(72) Inventor: Ryoichi CHIBA, Toyota-shi (JP)

(21) Appl. No.: 18/314,151

(22) Filed: May 9, 2023

(30) Foreign Application Priority Data
Jul. 1, 2022 (JP) 2022-107211

(51) Int. Cl. B60W 50/02; B60W 40/114; B60W 30/18

(52) U.S. Cl. CPC B60W 50/0205; B60W 40/114; B60W 30/18159; B60W 2050/021; B60W 2520/14; B60W 2540/18

(57) ABSTRACT

A driving diagnosis unit is provided that determines that when a condition that a blinker lever of a vehicle is moved to a predetermined position and the vehicle travels forward is satisfied, when an absolute value of an accumulated value of a yaw angle of the vehicle in a direction indicated by the blinker lever is equal to or less than a first threshold value and when an absolute value of a steering angle of a steering wheel of the vehicle indicates that the steering wheel rotates in a direction opposite to the direction indicated by the blinker lever by a second threshold value or more, the vehicle travels at an intersection while the vehicle pushes in the opposite direction.

### CROSS-REFERENCE TO RELATED APPLICATION

This application claims priority to Japanese Patent Application No. 2022-107211 filed on Jul. 1, 2022, incorporated herein by reference in its entirety.

### BACKGROUND

### 1. Technical Field

The present disclosure relates to a driving diagnosis device, a driving diagnosis system, a driving diagnosis method, and a storage medium.

### 2. Description of Related Art

Japanese Unexamined Patent Application Publication No. 2017-054343 (JP 2017-054343 A) described below discloses a disclosure capable of detecting a vehicle traveling while a large turn.

### SUMMARY

The disclosure disclosed in JP 2017-054343 A cannot accurately determine whether a vehicle is traveling at an intersection while pushing in a direction opposite to a direction indicated by a blinker lever.

In view of the above fact, it is an object of the present disclosure to provide a driving diagnosis device, a driving diagnosis system, a driving diagnosis method, and a storage medium capable of accurately determining whether a vehicle is traveling at an intersection while pushing in a direction opposite to a direction indicated by a blinker lever.

A first aspect of the present disclosure relates to a driving diagnosis device including a driving diagnosis unit configured to determine that when a condition that a blinker lever of a vehicle is moved to a predetermined position and the vehicle travels forward is satisfied, when an absolute value of an accumulated value of a yaw angle of the vehicle in a direction indicated by the blinker lever is equal to or less than a first threshold value and when an absolute value of a steering angle of a steering wheel of the vehicle indicates that the steering wheel rotates in a direction opposite to the direction indicated by the blinker lever by a second threshold value or more, the vehicle travels at an intersection while the vehicle pushes in the opposite direction.

With the above configuration, the driving diagnosis device can accurately determine whether the vehicle is traveling at the intersection while pushing in the direction opposite to the direction indicated by the blinker lever.

In the first aspect, the driving diagnosis unit may determine that when an absolute value of a yaw rate of the vehicle in the opposite direction is equal to or greater than a third threshold value, the vehicle travels at the intersection while the vehicle pushes in the opposite direction.

With the above configuration, it is possible to more accurately determine whether the vehicle is traveling at the intersection while pushing in the direction opposite to the direction indicated by the blinker lever.

A second aspect of the present disclosure relates to a driving diagnosis system including a yaw angle detector, a steering angle sensor, a blinker lever, and the driving diagnosis unit. The yaw angle detector is configured to detect a yaw angle. The steering angle sensor is configured to detect a steering angle.

A third aspect of the present disclosure relates to a driving diagnosis method including determining that when a condition that a blinker lever of a vehicle is moved to a predetermined position and the vehicle travels forward is satisfied, when an absolute value of an accumulated value of a yaw angle of the vehicle in a direction indicated by the blinker lever is equal to or less than a first threshold value and when an absolute value of a steering angle of a steering wheel of the vehicle indicates that the steering wheel rotates in a direction opposite to the direction indicated by the blinker lever by a second threshold value or more, the vehicle travels at an intersection while the vehicle pushes in the opposite direction.

A fourth aspect of the present disclosure relates to a storage medium storing a program that causes a computer to execute a process of determining that when a condition that a blinker lever of a vehicle is moved to a predetermined position and the vehicle travels forward is satisfied, when an absolute value of an accumulated value of a yaw angle of the vehicle in a direction indicated by the blinker lever is equal to or less than a first threshold value and when an absolute value of a steering angle of a steering wheel of the vehicle indicates that the steering wheel rotates in a direction opposite to the direction indicated by the blinker lever by a second threshold value or more, the vehicle travels at an intersection while the vehicle pushes in the opposite direction.

As described above, with each aspect of the present disclosure, it is possible to provide a driving diagnosis device, a driving diagnostic system, a driving diagnosis method, and a storage medium that have an excellent effect of being able to accurately determine whether a vehicle travels at an intersection while the vehicle pushes in a direction opposite to a direction indicated by a blinker lever.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a vehicle capable of transmitting a detected value to a driving diagnosis device according to an embodiment;

FIG. 2 is a diagram illustrating a driving diagnosis system including the driving diagnosis device, the vehicle, and a mobile terminal;

FIG. 3 is a control block diagram of a first server of the driving diagnosis device illustrated in FIG. 2;

FIG. 4 is a functional block diagram of a second server illustrated in FIG. 2;

FIG. 5 is a diagram illustrating a scene list;

FIG. 6 is a schematic plan view illustrating a state where the vehicle turns right or left at an intersection;

FIG. 7 is a flowchart illustrating processing executed by the second server;

FIG. 8 is a flowchart illustrating processing executed by a fourth server;

FIG. 9 is a flowchart illustrating processing executed by the mobile terminal illustrated in FIG. 2;

FIG. 10 is a diagram illustrating an image displayed on a display unit of the mobile terminal; and

FIG. 11 is a schematic plan view illustrating a state where the vehicle traveling on a curved road turns left at an intersection;

### DETAILED DESCRIPTION OF EMBODIMENTS

Hereinafter, embodiments of a driving diagnosis device 10, a driving diagnosis system 100, a driving diagnosis method, and a program according to the present disclosure will be described with reference to the drawings. The driving diagnosis system 100 (hereinafter referred to as system 100) of the present embodiment includes the driving diagnosis device 10, a vehicle 30, and a mobile terminal 50.

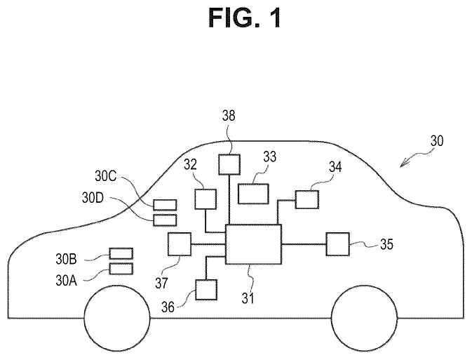

The vehicle 30 capable of data communication with the driving diagnosis device 10 via a network includes, as illustrated in FIG. 1, an electronic control unit (ECU) 31, a vehicle speed sensor 32, a shift lever 33, a shift position sensor 34, a yaw rate sensor (yaw angle detector) 35, a steering angle sensor 36, a blinker switch 37, and a global positioning system (GPS) receiver 38. A vehicle ID is given to the vehicle 30 capable of receiving diagnosis by the driving diagnosis device 10. The vehicle speed sensor 32, the shift position sensor 34, the yaw rate sensor 35, the steering angle sensor 36, the blinker switch 37, and the GPS receiver 38 are connected to the ECU 31. The ECU 31 is configured to include a CPU, a ROM, a RAM, a storage, a communication I/F, and an input/output I/F. The CPU, the ROM, the RAM, the storage, the communication I/F, and the input/output I/F of the ECU 31 are communicably connected to each other via a bus. The CPU of the ECU 31 performs controls of each configuration and various arithmetic processing (information processing) according to a program recorded in the ROM or the storage. Further, the CPU can acquire information about date and time from a timer (not illustrated). The ROM, the RAM, the storage, the communication I/F, and the input/output I/F of the ECU 31 have the same configurations and functions as those of a ROM 12B, a RAM 12C, a storage 12D, a communication OF 12E, and an input/output OF 12F of a first server 12, which will be described below. Details of these functions will be described below. The network described above includes a communication network of a communication provider and the Internet. The vehicle 30, the first server 12 described below, a fourth server 18, and the mobile terminal 50 perform data communication via the network.

Further, as illustrated in FIG. 1, the vehicle 30 has an accelerator pedal 30A and a brake pedal 30B. When the foot of a driver of the vehicle 30 depresses the accelerator pedal 30A, the ECU 31 controls a drive source (not illustrated) of the vehicle 30. The drive source of the vehicle 30 includes at least one of an internal combustion engine and an electric motor. When the foot of the driver depresses the brake pedal 30B, the ECU 31 controls a braking device (not illustrated) of the vehicle 30.

Further, the vehicle 30 has a steering wheel 30C. When the driver rotates the steering wheel 30C, a steering angle of the steering wheel 30C changes. Further, the vehicle 30 has a blinker lever 30D. The blinker lever 30D is rotatable from a predetermined neutral position (initial position) to a first position (predetermined position) on an upper side and a second position (predetermined position) on a lower side.

The vehicle 30 is provided with the vehicle speed sensor 32 that detects the vehicle speed of the vehicle 30. The shift lever 33 provided in the vehicle 30 is movable to shift positions of D (drive) range, R (reverse) range, P (parking) range, and N (neutral) range. That is, the vehicle 30 is an automatic vehicle (AT vehicle). A shift position sensor 34 detects the shift position of the shift lever 33. As is well known, when the shift lever 33 is in the D range, the vehicle 30 can travel forward by a driving force of the drive source, and when the shift lever 33 is in the R range, the vehicle 30 can travel in reverse by the driving force of the drive source. The yaw rate sensor 35 detects a yaw rate of the vehicle 30. In this specification, the sign representing the magnitude of a counterclockwise yaw angle of the vehicle 30 in plan view is (+), and the sign representing the magnitude of a clockwise yaw angle is (−). The steering angle sensor 36 detects the steering angle of the steering wheel 30C. In this specification, the sign representing the magnitude of a steering angle when the steering wheel 30C rotates counterclockwise as seen from the driver is (+), and the sign representing the magnitude of a steering angle when the steering wheel 30C rotates clockwise is (−). The blinker switch 37 detects an operation of the blinker lever 30D. For example, when the blinker switch 37 detects that the blinker lever 30D is positioned at the first position, a left direction indicator (not illustrated) provided on the vehicle 30 is turned on under the control of the ECU 31. On the other hand, when the blinker switch 37 detects that the blinker lever 30D is positioned at the second position, a right direction indicator (not illustrated) provided on the vehicle 30 is turned on under the control of the ECU 31. The GPS receiver 38 acquires information (hereinafter, referred to as “position information”) about a position at which the vehicle 30 is traveling by receiving a GPS signal transmitted from GPS satellites. Detected values detected by the vehicle speed sensor 32, the shift position sensor 34, the yaw rate sensor 35, the steering angle sensor 36, and the blinker switch 37 are transmitted to the ECU 31 via a controller area network (CAN) provided in the vehicle 30 and stored in the storage of the ECU 31 while being associated with time information representing the detected time and position information.

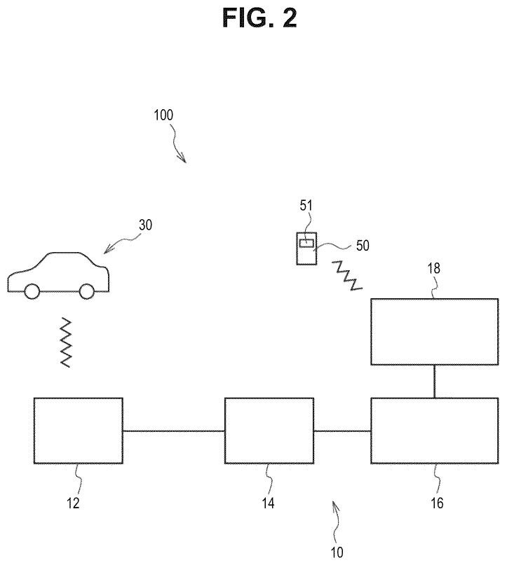

As illustrated in FIG. 2, the driving diagnosis device 10 includes the first server 12, a second server (driving diagnosis unit) 14, a third server 16, and the fourth server 18. For example, the first server 12, the second server 14, the third server 16, and the fourth server 18 are located in one building. The first server 12 and the fourth server 18 are connected to the network. The first server 12 and the second server 14 are connected by a local area network (LAN). The second server 14 and the third server 16 are connected by a LAN. The third server 16 and the fourth server 18 are connected by a LAN. That is, the driving diagnosis device 10 is constructed as a cloud computing system.

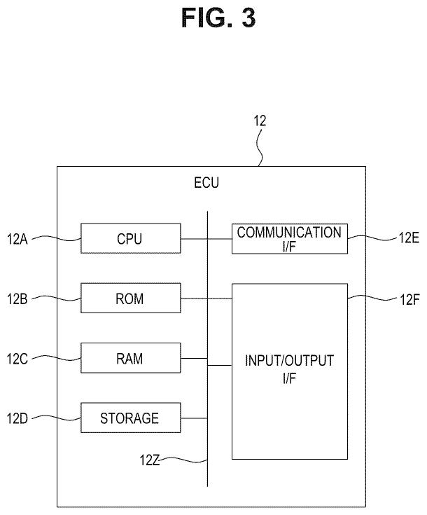

As illustrated in FIG. 3, the first server 12 includes a central processing unit (CPU: processor) 12A, a read only memory (ROM) 12B, a random access memory (RAM) 12C, a storage 12D, a communication interface (I/F) 12E, and an input/output OF 12F. The CPU 12A, the ROM 12B, the RAM 12C, the storage 12D, the communication OF 12E, and the input/output OF 12F are communicably connected to each other via a bus 12Z. The first server 12 can acquire information about date and time from a timer (not illustrated).

The CPU 12A is a central processing unit that executes various programs and controls each unit. That is, the CPU 12A reads a program from the ROM 12B or the storage 12D and executes the program using the RAM 12C as a work area. The CPU 12A performs controls of each configuration and various arithmetic processing (information processing) according to the program recorded in the ROM 12B or the storage 12D. The ROM 12B or the storage 12D is an example of a storage medium.

The ROM 12B stores various programs and various pieces of data. The RAM 12C temporarily stores programs or data as a work area. The storage 12D is configured by a storage device such as a hard disk drive (HDD) or a solid state drive (SSD), and stores various programs and various pieces of data. The communication OF 12E is an interface for the first server 12 to communicate with other devices. The input/output OF 12F is an interface for communicating with various devices.

Detected value data which is data representing detected values detected by the vehicle speed sensor 32, the shift position sensor 34, the yaw rate sensor 35, the steering angle sensor 36, the blinker switch 37, and the GPS receiver 38 of the vehicle 30 is transmitted from the communication I/F of the vehicle 30 to the communication OF 12E of the first server 12 via the network every time a predetermined time elapses, and the detected value data is recorded in the storage 12D. All pieces of detected value data recorded in the storage 12D include information on the vehicle ID, time information, and position information.

The basic configurations of the second server 14, the third server 16, and the fourth server 18 are the same as that of the first server 12.

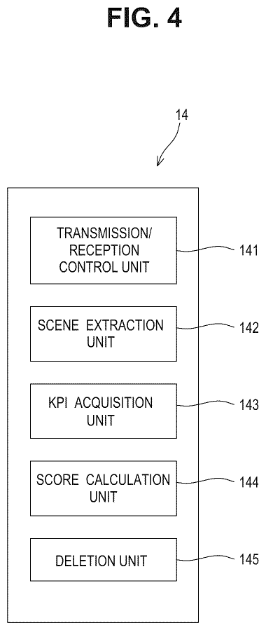

An example of a functional configuration of the second server (computer) 14 is illustrated in FIG. 4 as a block diagram. The second server 14 has a transmission/reception control unit 141, a scene extraction unit 142, a KPI acquisition unit 143, a score calculation unit 144, and a deletion unit 145 as functional configurations. The transmission/reception control unit 141, the scene extraction unit 142, the KPI acquisition unit 143, the score calculation unit 144, and the deletion unit 145 are implemented by the CPU of the second server 14 reading and executing programs stored in the ROM.

The transmission/reception control unit 141 controls the communication OF of the second server 14. The communication I/F of the second server 14 transmits and receives information to and from the communication I/Fs of the first server 12 and the third server 16 via LAN. The detected value data recorded in the storage 12D of the first server 12 is transmitted to the communication I/F of the second server 14 while being associated with the vehicle ID, the time information, and the position information. The detected value data transmitted from the first server 12 to the second server 14 includes data groups acquired during a predetermined data detection time. The data detection time is, for example, 30 minutes. Hereinafter, a group of pieces of data corresponding to one vehicle ID and acquired during the data detection time will be referred to as a “detected value data group”. The detected value data group recorded in the first server 12 is transmitted to the communication I/F of the second server 14 in chronological order of acquisition time. More specifically, when the detected value data group is deleted from the storage of the second server 14 as described below, a detected value data group newer than the detected value data group is transmitted from the first server 12 to the second server 14, and this new detected value data group is stored in the storage of the second server 14.

The scene extraction unit 142 distinguishes the detected value data group stored in the storage of the second server 14 into data representing specific detected values and other pieces of data. More specifically, the scene extraction unit 142 treats data necessary for acquiring KPIs, which will be described below, as data representing specific detected values.

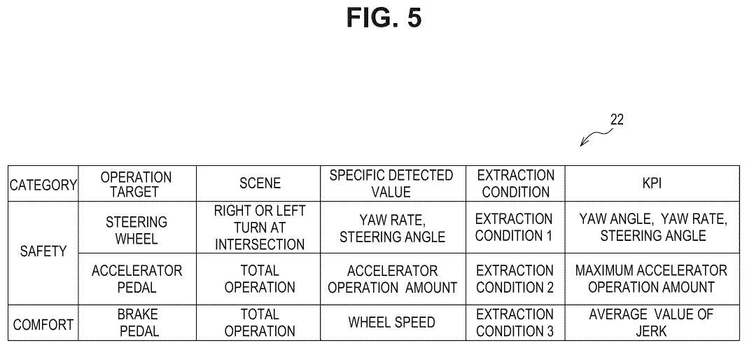

FIG. 5 illustrates a scene list 22 recorded in the ROM of the second server 14. The scene list 22 is defined based on operation content of various operation members of the vehicle 30. Categories that are the largest items in the scene list 22 are “safety” and “comfort”. The operation members defined in the scene list 22 include, for example, the accelerator pedal 30A, the brake pedal 30B, and the steering wheel 30C.

An extraction condition 1 included in the category “safety” is satisfied when all of the following conditions A, B, and C are satisfied.

Condition A: Shift lever 33 is in D range. Here, it is assumed that the shift lever 33 is moved from a shift position (P range, R range, N range) other than the D range to the D range at a predetermined movement time. Further, a time period between a first time that is a first predetermined time before the movement time and a second time that is a second predetermined time after the movement time is defined as an exclusion period. The condition A is not satisfied when the shift lever 33 is in the D range during this exclusion period. For example, the first predetermined time and the second predetermined time are 60 seconds.

Condition B: Vehicle speed must not be 0 km/h.

Condition C: Blinker lever 30D is in the first position or the second position.

The extraction condition 1 is associated with a scene, a specific detected value, and a KPI for the steering wheel 30C. The scene extraction unit 142 determines whether the extraction condition 1 is satisfied based on the detected values of the vehicle speed sensor 32, the shift position sensor 34, and the blinker switch 37. When the scene extraction unit 142 determines that the extraction condition 1 is satisfied, the scene extraction unit 142 extracts data detected by the yaw rate sensor 35 and the steering angle sensor 36 during the time period when the extraction condition 1 is satisfied from the detected value data group stored in the storage as data representing a specific detected value.

As illustrated in FIG. 5, the “safety” category of the scene list 22 includes extraction conditions different from the extraction condition 1, and the “comfort” category also includes extraction conditions different from the extraction condition 1. These extraction conditions are associated with scenes, specific detected values, and KPIs for the accelerator pedal 30A and the brake pedal 30B. A detailed description of these will be omitted.

The KPI acquisition unit 143 acquires (calculates) a key performance indicator (KPI) corresponding to a satisfied extraction condition when any of the extraction conditions described in the scene list 22 is satisfied.

For example, when the extraction condition 1 is satisfied, the KPI acquisition unit 143 acquires the detected values (specific detected values) of the yaw rate sensor 35 and the steering angle sensor 36, and a yaw rate Yr, a yaw angle θy, and a steering angle θs of the vehicle 30, which are values based on the detected values, as KPIs. The KPI acquisition unit 143 acquires a yaw angle θy by integrating the yaw rate Yr.

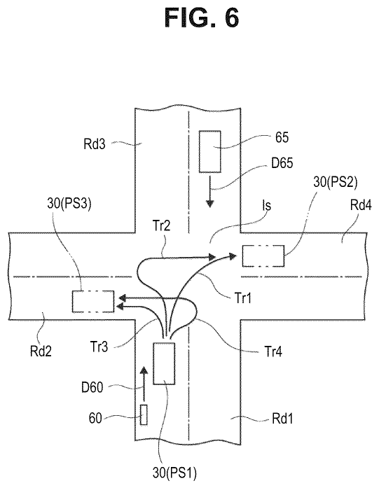

For example, as illustrated in FIG. 6, it is assumed that roads Rd1, Rd2, Rd3, and Rd4, which have a straight shape, are connected to an intersection Is, and the vehicle 30 is stopped at a first position PS1 near the end of the road Rd1 on the intersection Is side. The dashed dotted line in the drawing is a central separation line. In addition, it is assumed that the law of the country at which the roads Rd1, Rd2, Rd3, Rd4, and the intersection Is are established stipulates that vehicles travel on the left side. Here, it is assumed that the accelerator pedal 30A of the vehicle 30 with the shift lever 33 in the D range is depressed by the driver such that the vehicle 30 turns right and enters the road Rd4. Further, it is assumed that the vehicle 30 travels forward from the first position PS1 to a second position PS2 on the road Rd4 indicated by the imaginary line along a first trajectory Tr1 or a second trajectory Tr2.

Here, it is assumed that in a specific time period, which is the time period during which the vehicle 30 travels from the first position PS1 to the second position PS2, the shift lever 33 is in the D range, the vehicle speed is greater than 0 km/h, and the blinker lever 30D is in the second position. That is, it is assumed that the extraction condition 1 is satisfied in the specific time period. Here, when the vehicle 30 travels in a direction indicated by the blinker lever 30D, a turning direction of the vehicle 30 and a steering direction of the steering wheel 30C are referred to as a first direction. In addition, when the vehicle 30 travels in a direction opposite to the direction indicated by the blinker lever 30D, the turning direction of the vehicle 30 and the steering direction of the steering wheel 30C are referred to as a second direction. That is, when the blinker lever 30D is in the first position, a left turn direction of the vehicle 30 and a counterclockwise steering direction of the steering wheel 30C are the first direction, and a right turn direction of the vehicle 30 and a clockwise steering direction of the steering wheel 30C are the second direction. Similarly, when the blinker lever 30D is in the second position, a right turn direction of the vehicle 30 and a clockwise steering direction of the steering wheel 30C are the first direction, and the left turn direction of the vehicle 30 and the counterclockwise steering direction of the steering wheel 30C are the second direction.

Further, the steering angle θs in the first direction when an absolute value is maximum in a specific time period is defined as a first maximum steering angle θms1, and a total value (cumulative value) of the yaw angles θy in the first direction in the specific time period is defined as a first total yaw angle θyt1. Further, the steering angle θs in the second direction when the absolute value is maximum in a specific time period is defined as a second maximum steering angle θms2, and the yaw rate Yr in the second direction when the absolute value is maximum in the specific time period is defined as a second maximum yaw rate Yrm2.

The CPU of the second server 14 determines that the vehicle 30 travels while pushing in the second direction at the intersection Is when it determines that all of pushing conditions 1 to 5 below are satisfied based on the specific detected value. Hereinafter, traveling while the vehicle 30 pushes in the second direction will be referred to as “pushing traveling”. That is, in this case, there is a high possibility that the vehicle 30 in FIG. 6 traveled forward from the first position PS1 to the second position PS2 along the second trajectory Tr2. For example, there is a possibility that a two-wheeled vehicle 60 will go straight along an arrow D60 on a left side of the road Rd1, so it is not preferable for the vehicle 30 to travel along the second trajectory Tr2. Therefore, as will be described below, the score for the KPI is low when all pushing conditions 1 to 5 are satisfied. On the other hand, when at least one of the pushing conditions 1 to 5 is not satisfied, the CPU of the second server 14 determines that the vehicle 30 does not push-travel at the intersection Is. That is, in this case, there is a high possibility that the vehicle 30 in FIG. 6 traveled from the first position PS1 to the second position PS2 along the first trajectory Tr1. Therefore, as will be described below, the score for the KPI is high when at least one of the pushing conditions 1 to 5 is not satisfied.

Pushing condition 1: Absolute value of first total yaw angle θyt1 is equal to or less than first threshold value. The first threshold value is, for example, 150 degrees. Further, the sign of the first threshold value when the blinker lever 30D is in the first position is (+) and the sign of the first threshold value when the blinker lever 30D is in the second position is (−).

Pushing condition 2: Absolute value of second maximum steering angle θms2 is equal to or greater than second threshold value. The second threshold value is, for example, 25 degrees. Further, the sign of the second threshold value when the blinker lever 30D is in the first position is (−) and the sign of the second threshold value when the blinker lever 30D is in the second position is (+).

Pushing condition 3: Absolute value of second maximum yaw rate Yrm2 is equal to or greater than third threshold value. The third threshold value is, for example, 1.5 degrees/second. Additionally, the sign of the third threshold value when the blinker lever is in the first position is (−) and the sign of the third threshold value when the blinker lever 30D is in the second position is (+).

Pushing condition 4: Absolute value of first maximum steering angle θms1 is equal to or greater than fourth threshold value and equal to or less than fifth threshold value. The fourth threshold value is, for example, 60 degrees, and the fifth threshold value is, for example, 450 degrees. Further, the sign of the fourth and fifth threshold values when the blinker lever 30D is in the first position is (+), and the sign of the fourth and fifth threshold values when the blinker lever 30D is in the second position is (−).

Pushing condition 5: Length of specific time period, which is time when extraction condition 1 is satisfied, is equal to or longer than a sixth threshold value. The sixth threshold value is, for example, three seconds.

Further, it is assumed that the accelerator pedal 30A of the vehicle 30 is depressed by the driver such that the vehicle 30 turns left and enters the road Rd2 from the road Rd1, as illustrated in FIG. 6. More specifically, it is assumed that the vehicle 30 travels from the first position PS1 to a third position PS3 on the road Rd2 indicated by the imaginary line along a third trajectory Tr3 or a fourth trajectory Tr4. The CPU of the second server 14 determines that the vehicle 30 has push-traveled at the intersection Is when all of the pushing conditions 1 to 5 are satisfied. In this case, there is a high possibility that the vehicle 30 traveled from the first position PS1 to the third position PS3 along the fourth trajectory Tr4. For example, a vehicle 65 may go straight along an arrow D65 on the road Rd3, so it is not preferable for the vehicle 30 to travel along the fourth trajectory Tr4. On the other hand, when at least one of the pushing conditions 1 to 5 is not satisfied, the CPU of the second server 14 determines that the vehicle 30 does not push-travel at the intersection Is. In this case, there is a high possibility that the vehicle 30 traveled from the first position PS1 to the third position PS3 along the third trajectory Tr3.

The score calculation unit 144 calculates a safety degree score, a comfort degree score, and a driving operation score based on the calculated KPIs, as will be described below.

When the scene extraction unit 142, the KPI acquisition unit 143, and the score calculation unit 144 complete the above processing for one detected value data group recorded in the storage, the communication I/F of the second server 14 transmits the acquired data on the safety degree score, the comfort degree score, and the driving operation score to the communication I/F of the third server 16 together with information on the vehicle ID.

When the scene extraction unit 142, the KPI acquisition unit 143, and the score calculation unit 144 complete the above processing for one detected value data group, the deletion unit 145 deletes the detected value data group from the storage of the second server 14.

The communication I/F of the third server 16 receives the data on the safety degree score, the comfort degree score, and the driving operation score transmitted from the second server 14. These pieces of data received by the communication I/F of the third server 16 are recorded in the storage of the third server 16.

The fourth server 18 functions at least as a Web server and a web application server. The communication I/F of the fourth server 18 receives the data transmitted from the communication I/F of the third server 16 and records the received data in the storage.

The mobile terminal 50 illustrated in FIG. 2 includes a CPU, a ROM, a RAM, a storage, a communication I/F, and an input/output I/F. The mobile terminal 50 is, for example, a smart phone or a tablet computer. The CPU, ROM, RAM, storage, communication I/F, and input/output I/F of the mobile terminal 50 are communicably connected to each other via a bus. The mobile terminal 50 is provided with a display unit 51 having a touch panel. The display unit 51 is connected to the input/output I/F of the mobile terminal 50.

The mobile terminal 50 is owned, for example, by the driver of the vehicle 30 with the vehicle ID. A predetermined driving diagnosis display application is installed in the mobile terminal 50. The communication I/F of the mobile terminal 50 can wirelessly communicate with the communication I/F of the fourth server 18. That is, the communication I/F of the mobile terminal 50 can transmit and receive data to and from the communication I/F of the fourth server 18. The display unit 51 controlled by the CPU displays, for example, information received by the communication I/F from the communication I/F of the fourth server 18 and information input via the touch panel. Information input by the touch panel can be transmitted from the communication I/F of the mobile terminal 50 to the communication I/F of the fourth server 18.

Operation and Effect

Next, operations and effects of the present embodiment will be described.

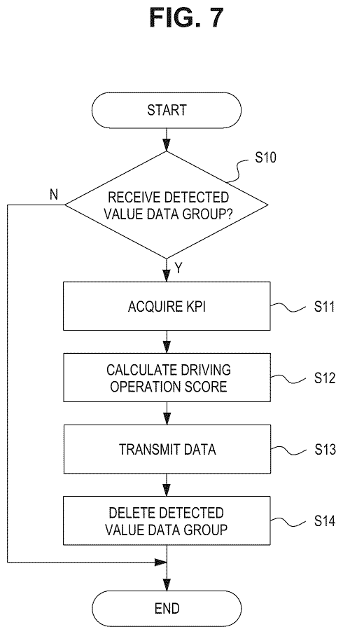

First, the flow of processing performed by the CPU (hereinafter referred to as a second CPU) of the second server 14 will be described using a flowchart of FIG. 7. The second CPU repeatedly executes the processing of the flowchart of FIG. 7 each time a predetermined time elapses.

First, in step S10 (hereinafter, the word “step” is omitted), the transmission/reception control unit 141 of the second server 14 determines whether the communication I/F has received the detected value data group from the first server 12. In other words, the transmission/reception control unit 141 determines whether the detected value data group is recorded in the storage of the second server 14.

When the transmission/reception control unit 141 makes a determination of YES in S10, the second CPU proceeds to S11, and the scene extraction unit 142 extracts data representing a specific detected value that satisfies the extraction condition from the detected value data group stored in the storage. Further, the KPI acquisition unit 143 acquires (calculates) each KPI based on the data representing the extracted specific detected value.

After the processing of S11 is completed, the second CPU proceeds to S12, and the score calculation unit 144 calculates the safety degree score, the comfort degree score, and the driving operation score.

For example, the score calculation unit 144 acquires KPIs (yaw rate Yr, yaw angle θy, and steering angle θs) related to the extraction condition 1 when the extraction condition 1 in FIG. 5 is satisfied and determines whether all of the pushing conditions 1 to 5 are satisfied. When all of the pushing conditions 1 to 5 are satisfied, the score for this KPI is one point. On the other hand, when at least one of pushing conditions 1 to 5 is not satisfied, the score for this KPI is 100 points.

When an extraction condition other than the extraction condition 1 is established, the score calculation unit 144 calculates the score for a KPI of each operation target.

In addition, the score calculation unit 144 calculates the safety degree score and the comfort degree score. A value (average value) obtained by dividing the total score for respective KPIs corresponding to the extraction conditions 1 to 3 by the number of items (2) in the category “safety” is the safety degree score. In the present embodiment, the number of items in the category “comfort” is “1”, so the score for the KPI corresponding to the extraction condition 4 is the comfort degree score.

Further, the score calculation unit 144 calculates a driving operation score based on the calculated safety degree score and comfort degree score. Specifically, the score calculation unit 144 acquires a value (average value) obtained by dividing the total score of the safety degree score and comfort degree score by the sum (3) of the items of the safety degree score and comfort degree score as the driving operation score.

After the processing of S12 is completed, the second CPU proceeds to S13, and the communication OF transmits the data on the safety degree score, the comfort degree score, and the driving operation score to the third server 16 together with the information regarding the vehicle ID.

After the processing of S13 is completed, the second CPU proceeds to S14, and the deletion unit 145 deletes the detected value data group from the storage of the second server 14.

When the transmission/reception control unit 141 makes a determination of NO in S10 or when the processing of S14 is completed, the second CPU temporarily ends the processing of the flowchart of FIG. 7.

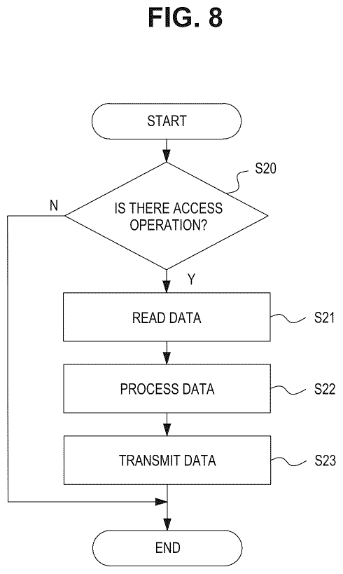

Next, the flow of processing performed by the CPU (hereinafter referred to as a fourth CPU) of the fourth server 18 will be described using a flowchart of FIG. 8. The fourth CPU repeatedly executes the processing of the flowchart in FIG. 8 every time a predetermined time elapses.

First, in S20, the fourth CPU of the fourth server 18 determines whether a display request has been transmitted from the communication I/F of the mobile terminal 50 in which a driving diagnosis display application is running to the communication I/F of the fourth server 18. That is, the fourth CPU determines whether there is an access operation from the mobile terminal 50. This display request includes information about the vehicle ID associated with the mobile terminal 50.

When the fourth CPU makes a determination of YES in S20, the fourth CPU proceeds to S21 and the communication I/F of the fourth server 18 communicates with the third server 16. The communication I/F of the fourth server 18 receives, from the communication I/F of the third server 16, data on the safety degree score, comfort degree score, and driving operation score corresponding to the vehicle ID associated with the mobile terminal 50 that transmitted the display request.

After the processing of S21 is completed, the fourth CPU proceeds to S22, and uses the data received in S21 to generate data representing a driving diagnosis result image 55 (see FIG. 10). The driving diagnosis result image 55 can be displayed by the display unit 51 of the mobile terminal 50 running the driving diagnosis display application.

After the processing of S22 is completed, the fourth CPU proceeds to S23, and the communication I/F of the fourth server 18 transmits the data generated in S22 to the communication I/F of the mobile terminal 50.

When the fourth CPU makes a determination of NO in S20 or when the processing of S23 is completed, the fourth CPU temporarily ends the processing of the flowchart in FIG. 8.

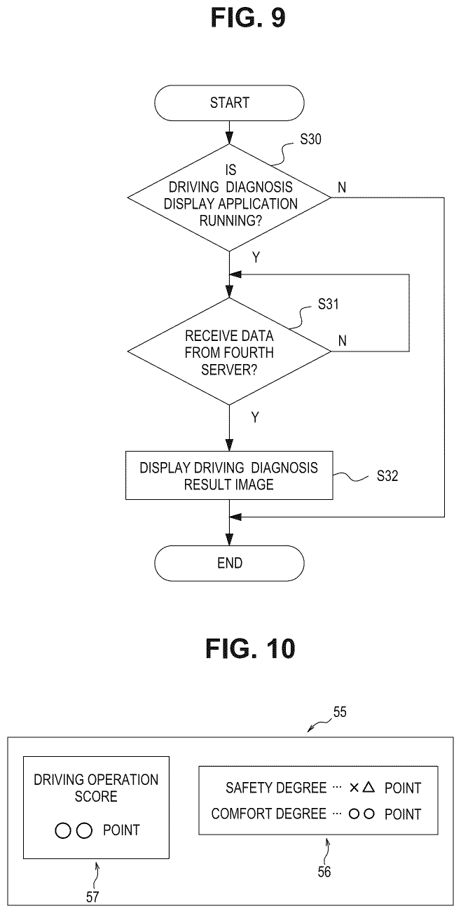

Next, a flow of processing performed by the CPU (hereinafter referred to as a terminal CPU) of the mobile terminal 50 will be described with reference to a flowchart in FIG. 9. The terminal CPU repeatedly executes the processing of the flowchart in FIG. 9 every time a predetermined time elapses.

First, in S30, the terminal CPU determines whether the driving diagnosis display application is running.

When the terminal CPU makes a determination of YES in S30, the terminal CPU proceeds to S31 to determine whether the communication I/F of the mobile terminal 50 has received data representing the driving diagnosis result image 55 from the communication I/F of the fourth server 18.

When the terminal CPU makes a determination of YES in S31, the terminal CPU proceeds to S32 and displays the driving diagnosis result image 55 on the display unit 51.

As illustrated in FIG. 10, the driving diagnosis result image 55 has a safety comfort degree display section 56 and a score display section 57. A safety degree score and a comfort degree score are displayed in the safety comfort degree display section 56. A driving operation score is displayed on the score display section 57.

When the terminal CPU makes a determination of NO in S30 or when the processing of S32 is completed, the terminal CPU temporarily ends the processing of the flowchart of FIG. 9.

As described above, the pushing conditions 1 and 3 of the present embodiment are conditions based on the yaw angle θy (first total yaw angle θyt1) and yaw rate Yr (second maximum yaw rate Yrm2), and the pushing conditions 2 and 4 are conditions based on the steering angle θs (first maximum steering angle θms1, second maximum steering angle θms2). Thus, the CPU of the second server 14 uses the steering angle θs in addition to the yaw angle θy (yaw rate Yr) to determine whether the vehicle 30 push-travels at the intersection Is. Therefore, the CPU of the second server 14 can accurately determine whether the vehicle 30 has push-traveled at the intersection Is.

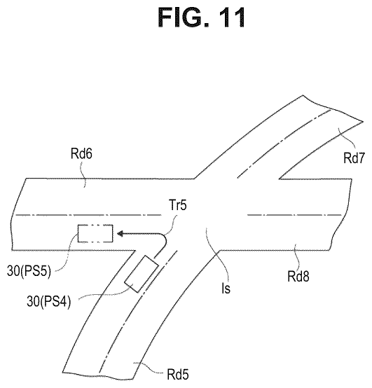

That is, for example, it is assumed that the pushing conditions 1 and 3 are used instead of the pushing conditions 2 and 4 to determine whether the vehicle 30 turning left at the intersection Is in FIG. 11 is push-traveling. Roads Rd5 and Rd7 having a curved shape and roads Rd6 and Rd8 having a straight shape are connected to the intersection Is, and the vehicle 30 stops at a fourth position PS4 near the end of the road Rd5 on the intersection Is side. It is assumed that when the accelerator pedal 30A of the vehicle 30 with the shift lever 33 in the D range is depressed by the driver, the vehicle 30 travels from the fourth position PS4 on the road Rd5 to a fifth position PS5 on the road Rd6 indicated by the imaginary line along a fifth trajectory Tr5. The fifth trajectory Tr5 is a travel trajectory along an extending direction of the road Rd5 and an extending direction of the road Rd6. However, when the vehicle 30 travels along the fifth trajectory Tr5, there is a high possibility that the pushing conditions 1 and 3 are satisfied. That is, although the vehicle 30 has traveled on a left side of a central separation line of the road Rd5 and a left side of a central separation line of the road Rd6, it may be erroneously determined that the vehicle 30 has push-traveled at the intersection Is.

On the other hand, in the present embodiment, the pushing conditions 2 and 4 are used in addition to the pushing conditions 1 and 3 to determine whether the vehicle 30 turning left at the intersection Is in FIG. 11 is push-traveling. When the vehicle 30 travels along the fifth trajectory Tr5 in this way, it is unlikely that an absolute value of the second maximum steering angle θms2 of the vehicle 30 will be equal to or greater than the second threshold value. Therefore, in such a case, in the present embodiment, it is not determined that the vehicle 30 has push-traveled at the intersection Is.

In addition, in the present embodiment using the pushing condition 3 in addition to the pushing conditions 1, 2, and 4, there is less possibility of erroneously determining that the vehicle 30 has push-traveled at the intersection Is compared to the case where the pushing condition 3 is not used. That is, it is assumed that the vehicle 30 scheduled to turn left at the intersection Is in FIG. 6 stops at the first position PS1 and the shift lever 33 is in the D range. In addition, it is assumed that the driver's body suddenly touches the steering wheel 30C, and the absolute value of the second maximum steering angle θms2 in a clockwise direction (second direction) of the steering wheel 30C of the stopped vehicle 30 becomes equal to or greater than the second threshold value. Therefore, in a case where the pushing condition 3 is not used, when the vehicle 30 starts moving while the absolute value of the second maximum steering angle θms2 is equal to or greater than the second threshold value, and then the steering wheel 30C is rapidly rotated in the first direction such that the vehicle 30 travels forward along the third trajectory Tr3, there is a high possibility that it will be erroneously determined that the vehicle 30 has push-traveled at the intersection Is.

On the other hand, in the present embodiment, there is little possibility of such an erroneous determination. That is, when the driver depresses the accelerator pedal 30A of the vehicle 30 that is stopped at the first position PS1 and the absolute value of the second maximum steering angle θms2 is equal to or greater than the second threshold value, the vehicle 30 travels forward. In this case, it is assumed that immediately after the vehicle 30 moves forward from the first position PS1, the driver rapidly rotates the steering wheel 30C counterclockwise to cause the vehicle 30 to travel along the third locus Tr3. Even when the rotational speed of the steering wheel 30C in this case is high, the absolute value of the second maximum yaw rate Yrm2 will never become equal to or greater than the third threshold value because the rotational direction of the steering wheel 30C is the first direction. That is, the pushing condition 3 is not satisfied. Therefore, when the pushing condition 3 is used as in the present embodiment, it is not erroneously determined that the vehicle 30 has push-traveled at the intersection Is.

Furthermore, in the present embodiment, when the shift lever 33 is in the D range during the exclusion period, the condition A, which is a requirement for establishment of the extraction condition 1, is not satisfied. The pushing conditions 1 to 5 may be satisfied when the vehicle 30 is moved into or out of a parking lot. However, when the vehicle 30 is moved into or out of the parking lot, there is a high possibility that the shift lever 33 will move between the P range, the R range, the N range, and the D range in a short period of time. Therefore, there is a high possibility that the condition A will not be satisfied when the vehicle 30 is moved into or out of the parking lot. Accordingly, in the present embodiment, when the vehicle 30 is put into or out of the parking lot, the possibility of erroneously determining that the vehicle 30 has push-traveled is low.

Furthermore, in the present embodiment, the extraction condition 1 is not satisfied when the condition B is not satisfied. That is, the yaw angle θy, yaw rate Yr, and steering angle θs acquired while the vehicle 30 is stopped are not applied to pushing conditions 1 to 5. Therefore, even when the steering angle of the steering wheel 30C is greatly changed by the driver while the vehicle 30 is stopped, it is not erroneously determined due to this that the vehicle 30 has push-traveled at the intersection Is.

As described above, the driving diagnosis device 10, the system 100, the driving diagnosis method, and the program of the present embodiment can accurately determine whether the vehicle 30 is push-traveling in the direction (second direction) opposite to the direction indicated by the blinker lever 30D at the intersection Is.

Further, in the present embodiment, driving diagnosis is performed using driving operation scores (KPI). Therefore, the driver who sees the driving diagnosis result image 55 can easily recognize the characteristics of his or her own driving operation.

Further, the KPI acquisition unit 143 performs KPI calculations using only specific detected values in the detected value data group. Therefore, a calculation load on the KPI acquisition unit 143 is smaller than when the KPI is calculated using all the detected value data groups. Therefore, the calculation load of the driving diagnosis device 10 is small.

Although the driving diagnosis device 10, the system 100, the driving diagnosis method, and the program according to the embodiment are described above, they can be appropriately modified in design without departing from the gist of the present disclosure.

The driving diagnosis result image 55 may include an image representing the result of the driving diagnosis regarding push-traveling. Further, this image may include time information representing the time when the pushing travel was performed and position information representing the position at which the pushing travel was performed. Further, the driving diagnosis result image 55 may include map data, and the map data may include information representing the time and position at which the pushing travel was performed. In this way, the driver who sees the driving diagnosis result image 55 displayed on the display unit 51 can recognize the time and position of the pushing travel that he or she has performed.

At least one of pushing conditions 1 to 5 may be eliminated. For example, the score for the KPI may be one point when all pushing conditions 1, 2, 4, and 5 are satisfied, and the score for the KPI may be 100 points when at least one of the pushing conditions 1, 2, 4, and 5 is not satisfied.

The driving diagnosis device 10 may be implemented in other configurations than those described above. For example, the first server 12, the second server 14, the third server 16, and the fourth server 18 may be realized by one server. In this case, for example, a hypervisor may be used to virtually partition the inside of the server into areas corresponding to the first server 12, the second server 14, the third server 16, and the fourth server 18, respectively.

The driving diagnosis device 10 may not be connected to the Internet. In this case, for example, the detected value data group acquired from the vehicle is recorded in a portable recording medium (for example, USB), and the detected value data group in this recording medium is copied to the first server 12.

Instead of the GPS receiver 38, the vehicle 30 may be equipped with a receiver capable of receiving information from a satellite (for example, Galileo) of a global navigation satellite system other than GPS.

The ECU 31 of the vehicle 30 may have functions corresponding to the scene extraction unit 142, the KPI acquisition unit 143, and the score calculation unit 144. That is, the ECU 31 may have a function as the driving diagnosis unit.

What is claimed is:

1. A driving diagnosis device that includes a driving diagnosis unit configured to determine that when a condition that a blinker lever of a vehicle is moved to a predetermined position and the vehicle travels forward is satisfied, when an absolute value of an accumulated value of a yaw angle of the vehicle in a direction indicated by the blinker lever is equal to or less than a first threshold value and when an absolute value of a steering angle of a steering wheel of the vehicle indicates that the steering wheel rotates in a direction opposite to the direction indicated by the blinker lever by a second threshold value or more, the vehicle travels at an intersection while the vehicle pushes in the opposite direction.

2. The driving diagnosis device according to claim 1, wherein the driving diagnosis unit is configured to determine that when an absolute value of a yaw rate of the vehicle in the opposite direction is equal to or greater than a third threshold value, the vehicle travels at the intersection while the vehicle pushes in the opposite direction.

3. A driving diagnosis system comprising:
a yaw angle detector configured to detect a yaw angle;
a steering angle sensor configured to detect a steering angle;
a blinker lever; and
the driving diagnosis unit according to claim 1.

4. A driving diagnosis method that includes determining that when a condition that a blinker lever of a vehicle is moved to a predetermined position and the vehicle travels forward is satisfied, when an absolute value of an accumulated value of a yaw angle of the vehicle in a direction indicated by the blinker lever is equal to or less than a first threshold value and when an absolute value of a steering angle of a steering wheel of the vehicle indicates that the steering wheel rotates in a direction opposite to the direction indicated by the blinker lever by a second threshold value or more, the vehicle travels at an intersection while the vehicle pushes in the opposite direction.

5. A non-transitory storage medium storing a program that causes a computer to execute a process of determining that when a condition that a blinker lever of a vehicle is moved to a predetermined position and the vehicle travels forward is satisfied, when an absolute value of an accumulated value of a yaw angle of the vehicle in a direction indicated by the blinker lever is equal to or less than a first threshold value and when an absolute value of a steering angle of a steering wheel of the vehicle indicates that the steering wheel rotates in a direction opposite to the direction indicated by the blinker lever by a second threshold value or more, the vehicle travels at an intersection while the vehicle pushes in the opposite direction.
